(19) United States
(12) Patent Application Publication
(10) Pub. No.: US 2014/0171204 A1
(43) Pub. Date: Jun. 19, 2014

(54) ASYNCHRONOUS CLOUD RENDERED VIDEO DELIVERY

(71) Applicant: MICROSOFT CORPORATION, Redmond, WA (US)

(72) Inventors: Anthony J. Cox, Seattle, WA (US); Thomas W. Miller, Redmond, WA (US)

(73) Assignee: MICROSOFT CORPORATION, Redmond, WA (US)

(21) Appl. No.: 13/713,689

(22) Filed: Dec. 13, 2012

(51) Int. Cl. A63F 13/12

(52) U.S. Cl. CPC A63F 13/12
USPC 463/42

(57) ABSTRACT

Asynchronous cloud rendered video delivery systems and methods are provided. According to one aspect, the method may include at a turn-based game program executed by a game server, receiving a turn input from a client device via a wide area network; determining that a turn advance occurs within the turn-based game program, and determining at least one rendering event associated with the turn advance. The method may further include sending a rendering request to generate a rendered video to a rendering server, receiving from the rendering server a message indicating that the rendering request has been completed, sending a turn available message to the client device, the turn available message including a network address of a storage server at which the rendered video is stored, to cause the client device to download and display the rendered video from the network address at the storage server.

### BACKGROUND

Mobile computing devices such as mobile telephones have become increasingly popular platforms for computer games. Many of these computer games include rendered graphics that provide visual interest to the user. However, several challenges exist for rendering graphics on such mobile computing devices. For example, mobile computing devices are generally equipped with slower processors, limited battery life, and low bandwidth network connections that are subject to sudden interruption. Rendering graphics with the hardware constraints of mobile computing devices is thus relatively processor intensive, taking time, consuming power, and generating heat. This can result in a degraded user experience due to decreased battery life, interruption in video rendering due to processor activity, etc. Mobile devices are also limited in their ability to quickly download large video files when connected to the Internet via mobile networks, such as 3G and 4G networks. This presents a difficulty in downloading large video files for display in computer games, as the download times may cause interruption or delay in the game as it is being played.

### SUMMARY

Asynchronous cloud rendered video delivery systems and methods are provided. According to one aspect, the method may include, at a turn-based game program executed by a game server, receiving a turn input from a client device via a wide area network, determining that a turn advance occurs within the turn-based game program, and determining at least one rendering event associated with the turn advance. The method may further include sending a rendering request to generate a rendered video to a rendering server, receiving from the rendering server a message indicating that the rendering request has been completed, sending a turn available message to the client device, the turn available message including a network address of a storage server at which the rendered video is stored, to cause the client device to download and display the rendered video from the network address at the storage server.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram illustrating an asynchronous cloud rendered video delivery system according to one embodiment.

FIG. 2 is a schematic diagram illustrating an example communication flow between various hardware components of the asynchronous cloud rendered video delivery system of FIG. 1.

FIG. 3 is an example computing device that may be used as the storage server, rendering server, game server, or client devices of the system of FIG. 1.

### DETAILED DESCRIPTION

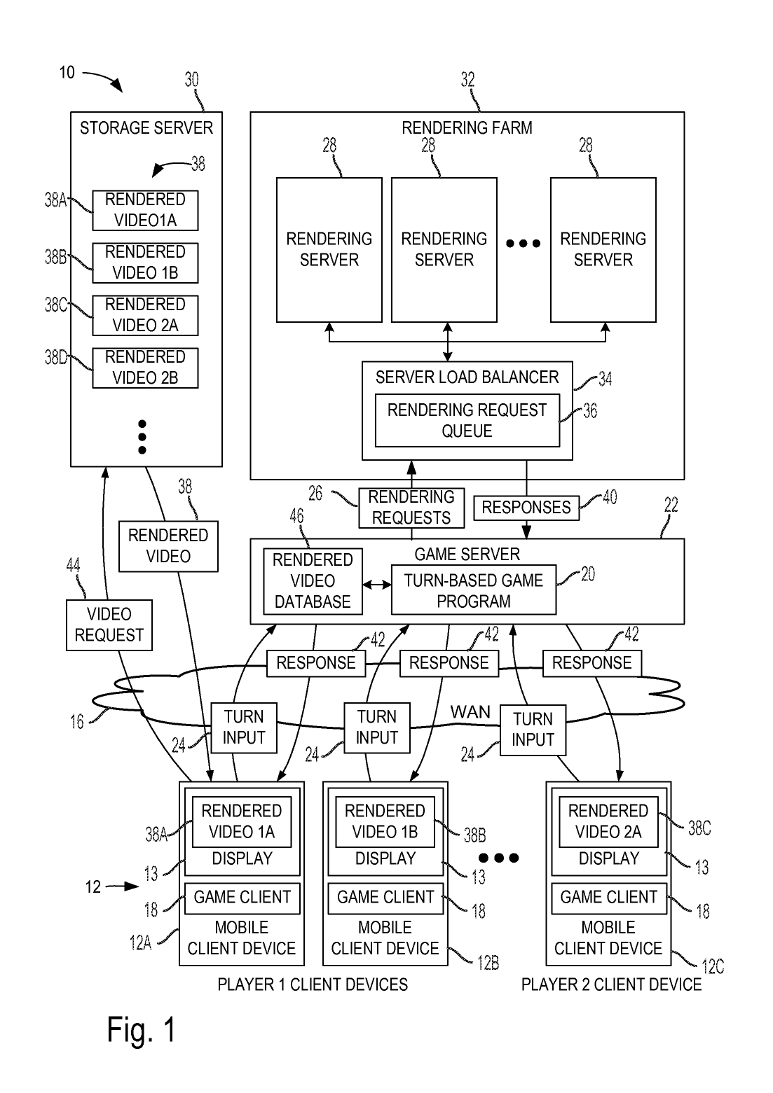

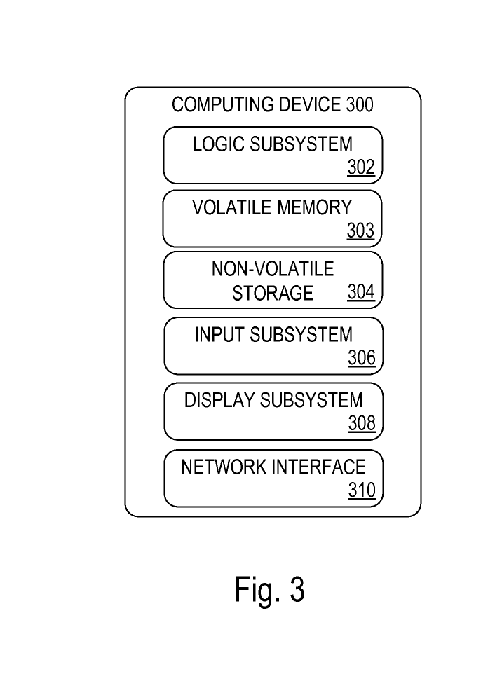

FIG. 1 illustrates schematically an example embodiment of an asynchronous cloud rendered video delivery system 10. System 10 includes a plurality of client devices 12 configured to communicate with a game server 22 via a wide area network 16 such as the Internet. It will be appreciated that one or more of client devices 12 may be a mobile computing device 12A configured to communicate via a wireless network connection with a mobile access network linked to the wide area network 16. One or more of the other computing devices 12 may be a desktop computing device 12B configured with a wired connection to the wide area network 16. These and other exemplary computing devices that may be used as client device 12 are described with reference to FIG. 3 below.

FIG. 1 illustrates for the purpose of example that a first player may access the game server 22 from both a mobile client device 12A, and a desktop client device 12B, during an asynchronous game session, and a second player in the same asynchronous game session may access the game server 22 from a mobile client 12C. In other configurations, additional players may access the game server 22 using a variety of different client devices 12. And in yet other examples, the turn-based game may be played in a single player mode, with only one player accessing the game server 22 for a game session.

Each client device 12 is configured to execute a turn-based game client 18. The turn-based game client 18 is configured to communicate with turn-based game program 20 executed by the game server 22, via wide area network 16. Among these communications is a turn input 24, generated by each participating client device 12, for each turn in the turn based game.

Accordingly, the turn-based game program 20 executed by server 22 is configured to receive the turn input 24 from each client device 12 via the wide area network 20. Upon receiving each turn input 24, the turn-based game program 20 applies game logic to the turn inputs, and determines that a turn advance occurs within the turn-based game program 20, based upon the game logic.

Various computations relating to the game are made at the turn advance, based on the game logic. For example, in some games, the movement and actions of various game objects within a virtual model of the gamespace is calculated, based upon the turn inputs 24. Further, the interactions between these game objects may be computed. Finally, the state of each game object may be updated at the end of the turn.

To prepare a video rendering of one or more events that took place during the turn, the turn-based game program 20 is configured to examine whether game events that are determined by game logic to be rendered, referred to as rendering events, took place during the turn. Thus, if and when the turn advance is detected, the turn-based game program 20 determines that at least one rendering event associated with the turn advance occurs, via game logic of the turn-based game program. Upon determining that a rendering event has occurred during the turn, the turn-based game program 20 sends a rendering request 26 to generate a rendered video to a rendering server 28. Typically the rendering request 26 is accompanied by sufficient instructions and data for the rendering server 28 to execute the rendering request. Each rendering server, it will be appreciated, may be equipped with dedicated graphical processing units that are configured to efficiently perform the rendering. Further, the rendering servers may be configured as virtualized machines running on hardware computing devices.

Prior to sending the rendering request 26, the turn-based game program 24 is configured to programmatically generate a network address and path (hereinafter collectively “network address”), such as a URL, to a network addressable location at which the rendered video will be stored in an associated cloud-based storage server 30 after generation by the rendering server 28. Thus, the rendering request 26 sent to the rendering server 28 by the game server 22 may be accompanied by the network address. The status of these rendering requests 26 and the associated network addresses assigned to each may be tracked by the game server 22 using a rendered video database 46. Upon sending the request the status of the requested video is indicated as “rendering request pending” in the database, and the network address at which the video will be made available is stored in the same or a linked record.

It will be appreciated that the rendering server 28 may be one of a plurality of rendering servers 28 included in a rendering farm 32. The rendering servers may include an associated server load balancer 34 logically positioned in the communication flow on a WAN side of the servers, and configured to broker requests and responses from client devices, and distribute the requests to different rendering servers 28, to thereby evenly distribute the request processing load among those servers. Accordingly, the server load balancer 34 may be configured to receive a rendering request 26 from the game server 22, place the rendering request 26 with other rendering requests in a rendering request queue 36, and assign a priority to the rendering request 26. It will be appreciated that each of the other rendering requests also having assigned priorities, and the server load balancer 34 is configured to distribute the rendering request 26 and the other rendering requests to one or more of the rendering servers 28 in order of the assigned priorities. Various parameters may be used to assign the priorities. For example, a rendering request 26 for turns of games played by players who have a special gaming status (e.g., “priority member”) may receive accelerated processing. Or, in an environment in which multiple turn-based game programs are sending rendering requests to the rendering farm, rendering requests in an asynchronous turn-based game program known to have a faster pace to its turns may receive accelerated processing.

The rendering server 28 is configured to receive the rendering request 26 from the game server 22, and based on the rendering request 26, render video to thereby produce a rendered video 38. The rendering server 26 is further configured to transmit the rendered video 38 to a storage server 30 for storage at a location on the storage server 30 accessible via the network address. The storage server 30 is configured to receive and store the rendered video 38 at the network address.

The game program 20 further receives from the rendering server 26 a response 40 including a message indicating that the rendering request 26 has been completed. In response, the game program 20 sends a response 42 including a turn available message to the client device 12 via the wide area network 16, the turn available message prompting the client device 12 to download a network address of the storage server 30 at which the rendered video 38 is stored, to cause the client device 12 to download and display the rendered video 38 from the network address at the storage server 30. Typically, the turn available message sent to the client device 12 by the game server 22 includes or provides a link to the network address for the location of the version of the rendered video 38 that has been determined to be appropriate for the client device. In some embodiments, the turn available message may be pushed to the client device through an appropriate push notification protocol, and may include an address on the game server at which additional turn information may be downloaded, and the network address at which the rendered video is stored may be retrieved from the game server after the push notification is received at the client.

Upon receiving the turn available message with associated network address, the client device 12 sends a video request 44 to the network address at the storage server 30, and downloads the appropriate version of the rendered video 38. It will be appreciated that upon receipt of the response 40 from the rendering server, the game server also updates the status of the requested video to “available” in the rendered video database 46.

In some embodiments, the rendering server 28 may be configured to render different resolutions of the rendered video 38. Thus, the rendered video 38 described above may be a first version 38A at first bit rate and resolution and the network address may be a first network address, and the rendering server 28 may be further configured to render video to produce a second version 38B of the rendered video at a lower bit rate and/or resolution than the first version 38A. The rendering server further may be configured to transmit the second version 38B of the rendered video to the storage server 30. Likewise, the storage server 30 may be further configured to receive and store the second version 38B of the rendered video at a second network address. It has been found that processing efficiencies can be achieved by rendering the different versions of the rendered video at approximately the same time, and thus, in some embodiments, the first and second versions of the video may be rendered in response to the same rendering request. Just as versions 38A and 38B are high and low resolution and bit rate versions of a first rendered video, the depicted versions 38C and 38D are high and low resolution and bit rate versions of a second rendered video.

Once these different versions 38A, 38B of the video are stored, the game server 22 may be further configured to detect or determine the capabilities of the requesting client device 12, and determine whether the first or second version of rendered video 38 is appropriate for the client device 12 based on the client device capabilities. It will be appreciated that typically high resolution high bit rate videos are sent to desktop computers with high bandwidth connections, whereas low bit rate, low resolution versions are sent to mobile devices with slower wireless connections to the internet and slower processor clock speeds. In the depicted example, player 1 views a high resolution high bit rate version 38B of a rendered video on a desktop client device 12B, and views a low resolution, low bit rate version 38A of the same rendered video on a mobile client device 12A. The game server has in each case received an indication of the client device capabilities, and sent the appropriate version of the rendered video to each client device. In an alternative embodiment, the client device may be configured to request the version of the video that is appropriate for its capabilities.

It will be appreciated that typically, a different cinematic animation is generated for each player participating in the turn based game; however, depending on the type of game, it may be desirable to transmit the same cinematic animation to more than one player. Thus, a version 38C of a second rendered video, in low resolution, low bit rate format, is sent to a client device for a second player, which is different from the rendered video 38A and 38B. Further, it will be appreciated that although two different versions of each rendered video are illustrated in FIG. 1, in other embodiments only one version of each rendered video may be created, or three or more different versions of each video may be created, depending upon the application.

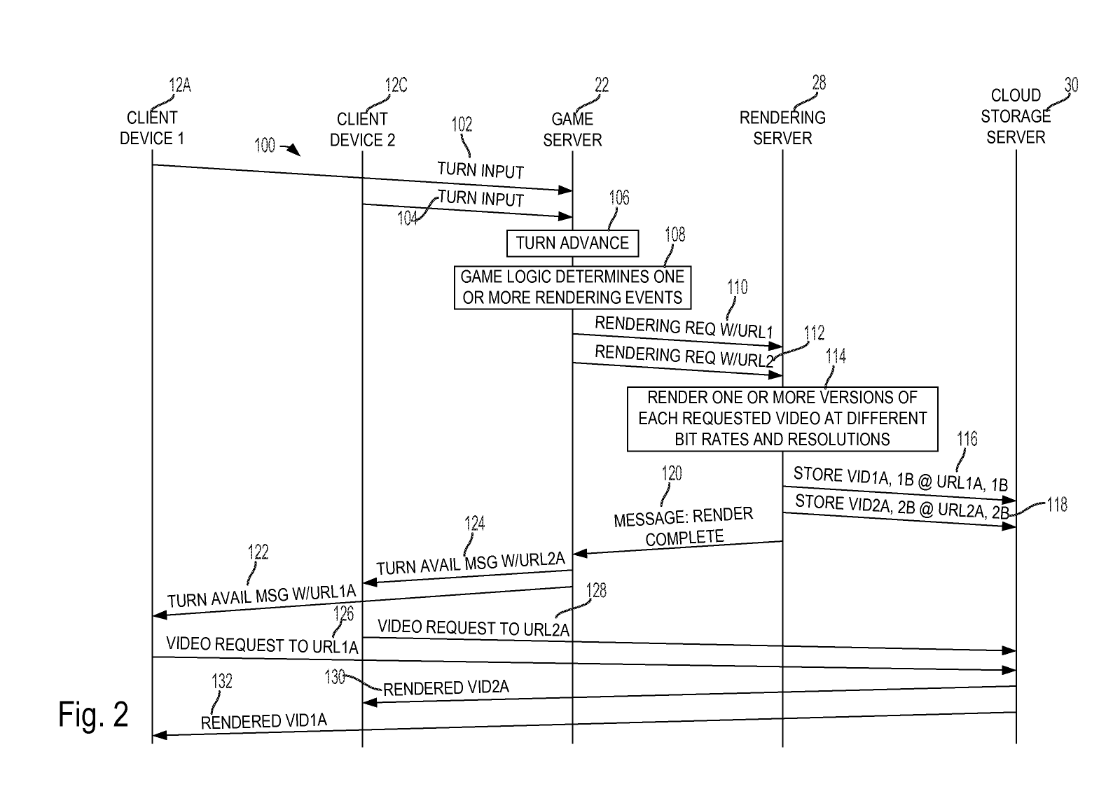

Turning now to FIG. 2, a communications flow diagram will be used to explain a method for asynchronous cloud rendered video delivery 100. The axes of FIG. 2 represent hardware components described above, which may be used to implement method 100, although it will be appreciated that other suitable computer hardware components may also be used. The communications flow illustrated in FIG. 2 is merely one example of such a communications flow. It will be appreciated that in other embodiments, the steps of method 100 may be performed in a different order, with some steps omitted, or with different components than depicted.

Method 100 may include, at a turn-based game program executed by a game server 22, at 102, receiving a first turn input from a first client device 12A, and at 104, receiving a second turn input from a second client device 12B. Although turn inputs from two client devices are depicted, it will be understood that turn inputs from a single client device, or more than two client devices may be received. At 106, upon receiving the first and second turn inputs, the method may include determining a turn advance occurs within the turn-based game program. At 108, the method may include determining at least one rendering event associated with the turn advance, via game logic of the turn-based game program. Typically the number of rendering events corresponds to the number of players participating in the turn. Thus, in the depicted embodiment, two client two rendering events are determined, one for player corresponding to each client device from which turn input was received.

At 110, the method may include sending a first rendering request to generate a first rendered video from the game server 22 to a rendering server 28, the rendering request being accompanied by a first network address indicating a first network addressable location within a cloud-based storage server 30 at which the first rendered video is to be stored after generation. At 112, the method may further include sending a second rendering request to generate a second rendered video to the rendering server, the second rendering request being accompanied by a second network address indicating a second network addressable location within the cloud-based storage server at which the second rendered video is to be stored after generation. As discussed above, these network addresses may be generated by the game server, and refer to a well-known, or shared secret address space hosted by the storage server 30.

At 114, the method may include, at the rendering server receiving each of the rendering requests from the game server, and based on each rendering request received, rendering each requested video to thereby produce one or more corresponding rendered videos. As discussed above, for each rendering request the requested video may be rendered in different versions, for example a first high resolution, high bit rate version (VID1A) and a second low resolution, low bit rate version (VID1B) for the first rendered video, and a first high resolution, high bit rate version (VID2A) and a second low resolution, low bit rate version (VID2B) for a second rendered video. The first and second versions of the rendered video are typically rendered in response to the same rendering request, to achieve processing efficiency, since producing the two versions at the same time is computationally more efficient than producing the two versions at different points in time. The status of these rendering requests and the associated network addresses assigned to each may be tracked by the game server using a rendered video database, as discussed above.

As illustrated at 116 and 118, the method further includes, at the rendering server 28, transmitting the rendered video to a storage server 30 for storage at a location on the storage server accessible via the network address. Once transmitted, the rendered video is received by the storage server and stored at the network address. In the depicted embodiment, the high resolution, high bit rate version and the low resolution, low bit rate version, of rendered video are transmitted to the server for each of the first rendered video and the second rendered video, as shown at 116 and 118. These videos are stored at respective network addresses (URL 1A, 1B and URL 2A, 2B) that have been received by the rendering server from the game server, and passed from the rendering server to the storage server with the storage request. As described above, the game program may generate the network address and the rendering request may be sent to the rendering server is accompanied by the network address. The status of these rendering requests for these rendered videos, and the address space in which they are stored on the storage server, are tracked by the game server in a rendered video database, as described above.

At 120, the method may further include, at the game server 22, receiving from the rendering server 28 a message indicating that the first and second rendering requests have been completed and the first and second rendered videos have been stored at the first and second network addresses within a cloud-based storage server. While in the depicted embodiment one message is received for both rendering requests sent at 110 and 112, in other embodiments a message may be received in response to each rendering request sent.

At 122 the method may include sending a first turn available message from the game server 22 to the first client device 12A, the first turn available message including or providing a link to a first network address (e.g., URL 1A) at which a first rendered video is stored, to cause the first client device 12A to download and display the first rendered video from the first network address location. At 124, the method may include sending a second turn available message to the second client device 12C, the second turn available message including or providing a link to a second network address (e.g., URL 2A) at which a second rendered video is stored, to cause the second client device 12C to download and display the second rendered video from the second network address location.

As discussed above, it should be understood that the rendering server 28 may be one of a plurality of rendering servers in a rendering farm, and a server load balancer may be provided to distribute incoming requests to the rendering servers. Further, as described above, after receiving the rendering request at a server load balancer associated with the rendering server, the rendering request may be placed with other rendering requests in a rendering request queue, and a priority may be assigned to the rendering request and each of the other rendering requests. The server load balancer may distribute the rendering request and the other rendering requests to the rendering servers in order of the assigned priorities. Although this priority queue is described as being implemented at a server load balancer in a rendering farm, in other embodiments such a prioritized request queue may be implemented in one or more of the rendering servers themselves.

The method may further include, at the game server, receiving an indication of the capabilities of the client device from the client device, determining whether the first or second version of rendered video is appropriate for the client device based on the client device capabilities, and including in the message sent to the client device, the network location of the version of the rendered video that has been determined to be appropriate for the client device. Thus, for example if the client device is a mobile device linked to the wide area network by a mobile network component, such as a 3G or 4G network, the game server is configured to include the network address for the low bit rate, low resolution version of the rendered video in the turn available message sent to the client device. Alternatively, the client device may be configured to request the appropriate version of the rendered video from the game server depending on the capabilities of the client device.

In some embodiments, the turn available message may be pushed to the client device through an appropriate push notification protocol, and may include an address on the game server at which additional turn information may be downloaded, and the network address at which the rendered video is stored may be retrieved from the game server after the push notification is received at the client.

The above described systems and methods may be utilized to generate rendered video from a cloud-based rendering farm and deliver appropriate versions to various requesting client devices from a cloud based-storage server, for display in an asynchronous turn-based game, thereby offloading the rendering burden from the client devices, while visually enhancing the game experience for players. Due to the asynchronous nature of the turn based game, players are accustomed to waiting a period of time at each turn for all players to provide their turn input, and thus players do not perceive the time taken to render the rendered video at the rendering farm as game delaying. Rather, the rendered video is typically ready for the user to view in a reasonable time, and typically by the next access of the client device by the user.

FIG. 3 schematically shows a non-limiting embodiment of a computing device 300 that can be used for the server or client devices of the system described above, and which can be used to implement the methods described above. Computing device 300 is shown in simplified form. It will be understood that virtually any computer architecture may be used without departing from the scope of this disclosure. In different embodiments, computing device 300 may take the form of a mainframe computer, server computer, desktop computer, laptop computer, tablet computer, home-entertainment computer, network computing device, gaming device, mobile computing device, mobile communication device (e.g., smart phone), etc.

Typically, mobile computing devices 12 typically are media players, smartphones, tablet computers, or electronic book readers, which include a battery for use when not connected to a mains power supply, a mobile oriented processor chipset with low power consumption and clock speed as compared to processor chipsets for desktops, comparatively smaller screens, WIFI and 3G or 4G mobile network wireless connections. Other client devices, such as desktop computing device 12B, may employ wired connections to the wide area network, and feature higher power processor chipsets and larger screens.

Computing device 300 includes a logic subsystem 302, volatile memory 303, and a non-volatile storage subsystem 304. Computing device 300 may also include a display subsystem 308, input subsystem 306, and communication subsystem 310, and/or other components not shown in FIG. 3.

Logic subsystem 302 includes one or more physical devices configured to execute instructions. For example, the logic subsystem may be configured to execute instructions that are part of one or more applications, services, programs, routines, libraries, objects, components, data structures, or other logical constructs. Such instructions may be implemented to perform a task, implement a data type, transform the state of one or more components, or otherwise arrive at a desired result.

The logic subsystem may include one or more processors configured to execute software instructions. Additionally or alternatively, the logic subsystem may include one or more hardware or firmware logic machines configured to execute hardware or firmware instructions. The processors of the logic subsystem may be single-core or multi-core, and the programs executed thereon may be configured for sequential, parallel or distributed processing. The logic subsystem may optionally include individual components that are distributed among two or more devices, which can be remotely located and/or configured for coordinated processing. Aspects of the logic subsystem may be virtualized and executed by remotely accessible, networked computing devices configured in a cloud-computing configuration.

Volatile memory 303 may include devices such as RAM that are used to temporarily contain data while it is being processed by the logic subsystem. It will be appreciated that data stored in volatile memory 303 is typically lost when power is cut.

Non-volatile storage subsystem 304 includes one or more physical devices configured to hold data and/or instructions in a non-volatile manner to be executed by the logic subsystem to implement the methods and processes described herein. Non-volatile storage subsystem 304 may include computer readable media (e.g., CD, DVD, HD-DVD, Blu-Ray Disc, FLASH memory, EEPROM, ROM, etc.), which may include removable media and/or built-in devices that hold instructions in a non-volatile manner, and thus continue to hold instructions when power is cut to the device. Non-volatile storage subsystem 304 may include other storage devices such as hard-disk drives, floppy-disk drives, tape drives, MRAM, etc.).

In some embodiments, aspects of the instructions described herein may be propagated over a communications medium, such as a cable or data bus, in a transitory fashion by a pure signal (e.g., an electromagnetic signal, an optical signal, etc.) that is not held by a physical device for a finite duration.

The terms “module,” “program,” and “engine” may be used to describe a software aspect of computing device 300 implemented to perform a particular function. In some cases, a module, program, or engine may be instantiated via logic subsystem 302 executing instructions held by non-volatile storage subsystem 304, using portions of volatile memory 503. It will be understood that the terms “module,” “program,” and “engine” may encompass individual or groups of executable files, data files, libraries, drivers, scripts, database records, etc.

Display subsystem 308 may include one or more displays, which may be integrated in a single housing with the remaining components of the computing device 300, as is typical of smart phone applications, laptop computers, etc., or may be separated and connected by a wired or wireless connection to the computing device, as is typical of desktop computers. The displays may be touch-sensitive for input, in some examples.

Input subsystem 306 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

Network interface 310 may be configured to communicatively couple computing device 300 with one or more other computing devices via a computer network, such as the Internet, utilizing a wired or wireless connection.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. An asynchronous cloud rendered video delivery system, comprising:
a game server configured to execute a turn-based game program, the turn-based game program being configured to:
receive a turn input from a client device via a wide area network;
upon receiving the turn input, determine that a turn advance occurs within the turn-based game program;
determine at least one rendering event associated with the turn advance, via game logic of the turn-based game program;
send a rendering request to generate a rendered video to a rendering server;
receive from the rendering server a message indicating that the rendering request has been completed; and
send a turn available message to the client device via the wide area network, the turn available message prompting the client device to download a network address of a storage server at which the rendered video is stored, to cause the client device to download and display the rendered video from the network address at the storage server.

2. The system of claim 1, wherein the rendering server is configured to:
receive the rendering request from the game server; and
based on the rendering request, render video to thereby produce a rendered video.

3. The system of claim 2, wherein the rendering server is one of a plurality of servers in a server farm, and wherein the server farm includes an associated server load balancer that is configured to:
receive the rendering requests from the game server;
place the rendering request with other rendering requests in a rendering request queue;
assign a priority to the rendering request, each of the other rendering requests also having assigned priorities; and
distribute the rendering request and the other rendering requests to one or more of the rendering servers in order of the assigned priorities.

4. The system of claim 2,
wherein the rendering server is further configured to transmit the rendered video to a storage server for storage at a location on the storage server accessible via the network address; and
wherein the storage server is configured to receive and store the rendered video at the network address.

5. The system of claim 2,
wherein the rendered video is a first version at first bit rate and resolution and the network address is a first network address;
wherein the rendering server is further configured to render video to produce a second version of the rendered video at a lower bit rate and/or resolution than the first version, and transmit the second version of the rendered video to the storage server; and
wherein the storage server is further configured to receive and store the second version of the rendered video at a second network address.

6. The system of claim 5, wherein the first and second versions of the video are rendered in response to the same rendering request.

7. The system of claim 6,
wherein the game server is further configured to receive an indication of capabilities of the client device from the client device, and determine whether the first or second version of rendered video is appropriate for the client device based on the client device capabilities; and
wherein the message sent to the client device by the game server includes the network location of the version of the rendered video that has been determined to be appropriate for the client device.

8. The system of claim 1,
wherein the game server executing the game program is configured to generate the network address indicating a network addressable location within the cloud storage server at which the rendered video is to be stored after generation; and
wherein the rendering request sent to the rendering server by the game server is accompanied by the network address.

9. The system of claim 1,
wherein the client device is a mobile device and the wide area network includes a mobile network component.

10. A method for asynchronous cloud rendered video delivery, comprising:
at a turn-based game program executed by a game server,
receiving a turn input from a client device via a wide area network;
upon receiving the turn input, determining that a turn advance occurs within the turn-based game program;
determining at least one rendering event associated with the turn advance, via game logic of the turn-based game program;
sending a rendering request to generate a rendered video to a rendering server;
receiving from the rendering server a message indicating that the rendering request has been completed; and
sending a turn available message to the client device via the wide area network, the turn available message including a network address of a storage server at which the rendered video is stored, to cause the client device to download and display the rendered video from the network address at the storage server.

11. The method of claim 10, further comprising, at the rendering server:
receiving the rendering request from the game server; and
based on the rendering request, rendering video to thereby produce a rendered video.

12. The method of claim 11, wherein the rendering server is one of a plurality of rendering servers in a rendering farm, the method further comprising:
at a server load balancer of the rendering farm:
receiving the rendering request from the game server;
placing the rendering request with other rendering requests in a rendering request queue;
assigning a priority to the rendering request and each of the other rendering requests; and
distributing the rendering request and the other rendering requests to the rendering servers in order of the assigned priorities.

13. The method of claim 11, further comprising,
at the rendering server, transmitting the rendered video to a storage server for storage at a location on the storage server accessible via the network address; and
at the storage server, receiving and storing the rendered video at the network address.

14. The method of claim 11, wherein the rendered video is a first version at first bit rate and resolution and the network address is a first network address, the method further comprising:
at the rendering server, rendering video to produce a second version of the rendered video at a lower bit rate and/or resolution than the first version;
at the rendering server, transmitting the second version of the rendered video to the storage server; and
at the storage server, receiving and storing the second version of the rendered video at a second network address.

15. The method of claim 14, wherein the first and second versions of the video are rendered in response to the same rendering request.

16. The method of claim 15, further comprising:
at the game server, receive an indication of the capabilities of the client device from the client device; and
determining whether the first or second version of rendered video is appropriate for the client device based on the client device capabilities; and
wherein the message sent to the client device includes the network location of the version of the rendered video that has been determined to be appropriate for the client device.

17. The method of claim 10,
wherein the game program is configured to generate the network address indicating a network addressable location within the storage server at which the rendered video is to be stored after generation; and
wherein the rendering request sent to the rendering server is accompanied by the network address.

18. The method of claim 10,
wherein the client device is a mobile device and the wide area network includes a mobile network component.

19. The method of claim 10, further comprising:
wherein the turn input is a first turn input and the client device is a first client device, the method further comprising:
receiving a second turn input from a second client device;
wherein determining a turn advance occurs within the turn-based game program upon receiving the first and second turn inputs;
wherein the rendering request is a first rendering request, the rendered video is a first rendered video, and the network address is a first network address indicating a first network addressable location;
the method further comprising:
sending a second rendering request to generate a second rendered video to the rendering server, the second rendering request being accompanied by a second network address indicating a second network addressable location within the cloud storage server at which the second rendered video is to be stored after generation;
wherein a message additionally indicates that the second rendering request has been completed and the second rendered video has been stored at the second network address within a cloud storage server;
wherein the turn available message is a first turn available message including the first network address at which the first rendered video is stored, the method further comprising:
sending a second turn available message to the second client device, the second turn available message including a second network address at which a second rendered video is stored, to cause the second client device to download and display the second rendered video from the second network address location.

20. A method for asynchronous cloud rendered video delivery, comprising:
at a turn-based game program executed by a game server,
receiving a first turn input from a first client device;
receiving a second turn input from a second client device;
upon receiving the first and second turn inputs, determining a turn advance occurs within the turn-based game program;
determining at least one rendering event associated with the turn advance, via game logic of the turn-based game program;
sending a first rendering request to generate a first rendered video to a rendering server, the rendering request being accompanied by a first network address indicating a first network addressable location within a cloud storage server at which the first rendered video is to be stored after generation;
sending a second rendering request to generate a second rendered video to the rendering server, the second rendering request being accompanied by a second network address indicating a second network addressable location within the cloud storage server at which the second rendered video is to be stored after generation;
receiving from the rendering server a message indicating that the first and second rendering requests have been completed and the first and second rendered videos have been stored at the first and second network addresses within a cloud storage server;
sending a first turn available message to the first client device, the first turn available message including a first network address at which a first rendered video is stored, to cause the first client device to download and display the first rendered video from the first network address location; and
sending a second turn available message to the second client device, the second turn available message including a second network address at which a second rendered video is stored, to cause the second client device to download and display the second rendered video from the second network address location.
